(19) United States
(12) Patent Application Publication
(10) Pub. No.: US 2003/0190509 A1
(43) Pub. Date: Oct. 9, 2003

(54) PHASE SEPARATOR WITH SEPARATION ENHANCING BAFFLES

(76) Inventors: Robert H. Byron JR., Glastonbury, CT (US); Michael Brown, Ellington, CT (US)

Correspondence Address: CANTOR COLBURN, LLP, 55 GRIFFIN ROAD SOUTH, BLOOMFIELD, CT, 06002

(21) Appl. No.: 10/249,349

(22) Filed: Apr. 2, 2003

Related U.S. Application Data
(60) Provisional application No. 60/370,059, filed on Apr. 3, 2002.

(51) Int. Cl. H01M 8/06; H01M 8/04; B01D 53/00

(52) U.S. Cl. 429/21; 96/239

(57) ABSTRACT

A gas/liquid separator comprises: a vessel having a fluid inlet, a liquid outlet, a vapor outlet and a vessel cross-sectional geometry, an initial baffle and a subsequent baffle disposed within the vessel, between the fluid inlet and the vapor outlet, and having a baffle geometry substantially similar to the vessel cross-sectional geometry, and a solid plate disposed between the initial baffle and the vapor outlet, wherein the vapor outlet is in gaseous communication with a side of the solid plate opposite the vapor outlet. The initial and subsequent baffles comprise a plurality of openings providing fluid communication from a fluid inlet side to a baffle vapor outlet side of the initial baffle and the subsequent baffle.

### CROSS REFERENCE TO RELATED APPLICATIONS

This application claims priority to U.S. Provisional Patent Application No. 60/370,059 filed Apr. 3, 2002, which is incorporated herein by reference in its entirety.

### BACKGROUND OF INVENTION

This disclosure relates to electrochemical cell systems, and, more particularly, to a phase separation unit having baffles that enhance the separation of liquid and vapor phases.

Electrochemical cells are energy conversion devices, usually classified as either electrolysis cells or fuel cells. Proton exchange membrane electrolysis cells can function as hydrogen generators by electrolytically decomposing water to produce hydrogen and oxygen gases. Referring to FIG. 1, a section of an anode feed electrolysis cell of the prior art is shown generally at 10 and is hereinafter referred to as “cell 10.” Reactant water 12 is fed into cell 10 at an oxygen electrode (anode) 14 to form oxygen gas 16, electrons, and hydrogen ions (protons) 15. The chemical reaction is facilitated by the positive terminal of a power source 18 connected to anode 14 and the negative terminal of power source 18 connected to a hydrogen electrode (cathode) 20. Oxygen gas 16 and a first portion 22 of water are discharged from cell 10, while protons 15 and second portion 24 of the water migrate across a proton exchange membrane 26 to cathode 20. At cathode 20, hydrogen gas 28 is formed and removed, generally through a gas delivery line. The removed hydrogen gas 28 is usable in a myriad of different applications. Second portion 24 of water, which is entrained with hydrogen gas, is also removed from cathode 20.

An electrolysis cell system may include a number of individual cells arranged in a stack with reactant water being directed through the cells via input and output conduits formed within the stack structure. The cells within the stack are sequentially arranged, and each one includes a membrane electrode assembly defined by a proton exchange membrane disposed between a cathode and an anode. The cathode, anode, or both may be gas diffusion electrodes that facilitate gas diffusion to the proton exchange membrane. Each membrane electrode assembly is in fluid communication with a flow field positioned adjacent to the membrane electrode assembly. The flow fields are defined by structures configured to facilitate fluid movement and membrane hydration within each individual cell.

The portion of water entrained with the hydrogen gas is discharged from the cathode side of the cell and is fed to a phase separation unit to separate the hydrogen gas from the water, thereby increasing the hydrogen gas yield and the overall efficiency of the cell in general. Typical phase separation units facilitate the separation of water from hydrogen gas utilizing passive settling techniques in which the hydrogen diffuses through the liquid phase directly to a vapor phase. The vapor phase is then passed through a drying apparatus, which, depending on the water content of the hydrogen gas, oftentimes requires significant power inputs to attain the desired level of dryness of the product hydrogen gas.

While existing phase separation units are suitable for their intended purposes, there still remains a need for improvements, particularly regarding the removal of water from the hydrogen gas exiting the phase separation unit. Therefore, a need exists for a phase separation unit that is capable of providing substantially completely dry product hydrogen gas in order to reduce the required power inputs to ancillary drying apparatuses.

### SUMMARY OF INVENTION

Disclosed herein are embodiments of a gas/liquid separator, a gas generating system, and a method of separating a gas phase from a liquid phase. In one embodiment, the gas/liquid separator comprises: a vessel having a fluid inlet, a liquid outlet, a vapor outlet and a vessel cross-sectional geometry, an initial baffle and a subsequent baffle disposed within the vessel, between the fluid inlet and the vapor outlet, and having a baffle geometry substantially similar to the vessel cross-sectional geometry, and a solid plate disposed between the initial baffle and the vapor outlet, wherein the vapor outlet is in gaseous communication with a side of the solid plate opposite the vapor outlet. The initial and subsequent baffles comprise a plurality of openings providing fluid communication from a fluid inlet side to a baffle vapor outlet side of the initial baffle and the subsequent baffle. In one embodiment, the gas generating system comprises an electrochemical cell, and the gas/liquid phase separator in fluid communication with said electrochemical cell.

In one embodiment, the method of separating a gas phase from a liquid phase comprises: introducing a stream to a gas/liquid separator, passing an initial portion of the stream through an initial baffle, passing a subsequent portion of the stream through a subsequent baffle, wherein vapor and liquid are separated from the stream, and removing the vapor from the separator.

The above discussed and other features will be appreciated and understood by those skilled in the art from the following detailed description and drawings.

### BRIEF DESCRIPTION OF DRAWINGS

Referring now to the drawings, which are meant to be exemplary and not limiting, and wherein like elements are numbered alike in the several FIGURES.

FIG. 1 is a schematic representation of an anode feed electrolysis cell of the prior art.

FIG. 2 is a schematic representation of a gas generating apparatus into which an electrolysis cell system may be incorporated.

FIG. 3 is an exploded perspective view of a phase separator.

FIG. 4 is an exploded perspective view of a phase separator incorporating a cooling apparatus therein to more efficiently effect the condensation of water from a vapor phase.

### DETAILED DESCRIPTION

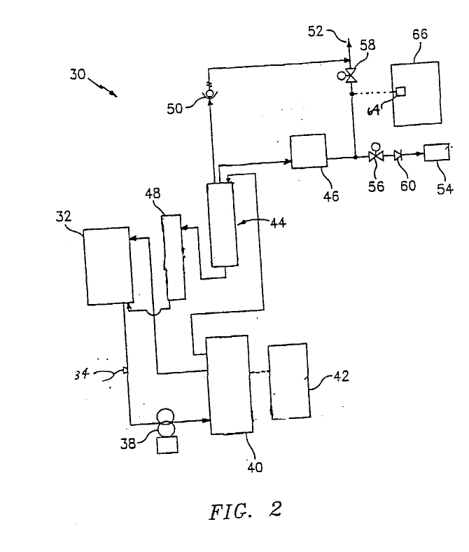

Referring to FIG. 2, an exemplary embodiment of an electrolysis cell system is shown generally at 30 and is hereinafter referred to as “system 30.” System 30 is suitable for generating hydrogen for use in gas chromatography, as a fuel, and for various other applications. It is to be understood that while the gas/liquid separator described below is described in relation to an electrolysis cell, it is generally applicable to both electrolysis and fuel cells, particularly regenerative fuel cells, as well as other systems. Furthermore, although the description and figures are directed to the production of hydrogen and oxygen gas by the electrolysis of water, the apparatus is applicable to the generation of other gases from other reactant materials.

Exemplary system 30 includes a water-fed electrolysis cell capable of generating gas from reactant water and is in operable communication with a control system. Reactant water, preferably deionized, distilled water, is supplied from a water source 32. The reactant water utilized by system 30 is stored in water source 32 and is fed by gravity or pumped through a pump 38 into an electrolysis cell stack 40. The supply line, which is preferably clear plasticizer-free tubing, optionally includes an electrical conductivity sensor 34 disposed therewithin to monitor the electrical potential of the water, thereby determining its purity and ensuring its adequacy for use in system 30.

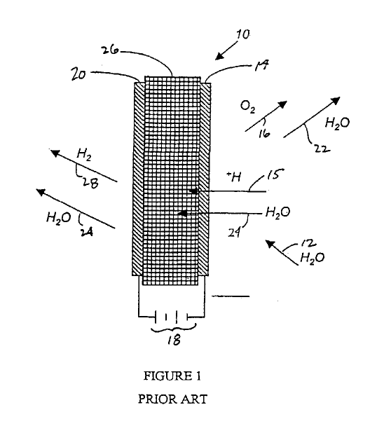

Cell stack 40 comprises a plurality of cells (e.g., similar to cell 10 described above with reference to FIG. 1) encapsulated within sealed structures (not shown). The reactant water is received by manifolds or other types of conduits (not shown) that are in fluid communication with the cell components. An electrical source 42 is disposed in electrical communication with each cell within cell stack 40 to provide a driving force for the dissociation of the water.

Oxygen and water exit cell stack 40 via a common stream that recycles the oxygen and water to water source 32 where the oxygen is vented to the atmosphere. The hydrogen stream, which is entrained with water, exits cell stack 40 and is fed to a gas/liquid separator or phase separation tank, which is a hydrogen/water separation apparatus 44, hereinafter referred to as “separator 44,” where the gas and liquid phases are separated. The exiting hydrogen gas (having a lower water content than the hydrogen stream to separator 44) is optionally further dried at a drying unit 46, which may be, for example, a diffuser, a pressure swing absorber, desiccant, or the like.

Water with trace amounts of hydrogen entrained therein is returned to water source 32 from separator 44 through a low-pressure hydrogen separator 48. Low pressure hydrogen separator 48 allows hydrogen to escape from the water stream due to the reduced pressure, and also recycles water to water source 32 at a lower pressure than the water exiting separator 44. Separator 44 also includes a release 50, which may be a relief valve, to rapidly purge hydrogen to a hydrogen vent 52 when the pressure or pressure differential exceeds a pre-selected limit.

Hydrogen from drying unit 46 is fed to a hydrogen storage facility 54. Optional valves 56, 58, disposed at various points on the system lines, are configured to release hydrogen to vent 52 under certain conditions, while an optional check valve 60 prevents the backflow of hydrogen to drying unit 46 and separator 44.

Additional equipment that can be employed in system 30 includes a ventilation system (e.g., a fan, a blower, and the like), control mechanisms (e.g., sensor(s), switch (es), transducer(s), and the like), compressor(s), pump(s), valves (e.g., check valve(s), purge valve(s), relief valve(s), and the like), and filter(s), as well as combinations comprising at least one of the foregoing pieces of equipment.

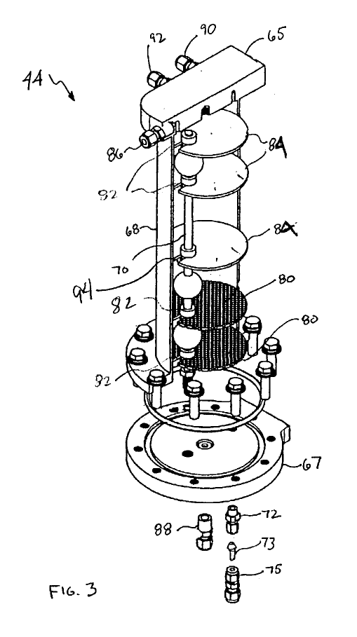

Referring now to FIG. 3, one exemplary embodiment of separator 44 and its componentry is shown in greater detail. Separator 44 comprises various materials including metals, plastics, and combinations comprising at least one of the foregoing materials that preferably allow separator 44 to receive the gas/liquid stream at the pressure it exits the cell. Pressures can be up to and exceeding about 10,000 psi, with pressures of less than or equal to about 6,500 psi typical, pressures of less than or equal to about 2,500 psi more common, and pressures of about 1,000 psi to about 2,250 psi preferred. Metals that may be used to fabricate the various portions of separator 44 include, but are not limited to, ferrous materials (e.g., stainless steels and the like), titanium, nickel, and the like, as well as oxides, cermets, composites, alloys, and mixtures comprising at least one of the foregoing metals. Some possible plastics that may be used to fabricate the various portions of separator 44 include, but are not limited to, polycarbonates, polyethylenes, polypropylenes, and the like, as well as reaction products and mixtures comprising at least one of the foregoing plastics.

Separator 44, which is essentially a containment vessel, comprises a shell 68, a flange 67, and an end cap 65. A fluid inlet 72 for receiving the wet hydrogen stream from the cell stack is disposed at flange 67. Alternately, fluid inlet 72 may be disposed directly in shell 68 proximate the flange end of separator 44. In either configuration, fluid inlet 72 receives the wet hydrogen stream via a connector 73 disposed at a union 75 that is in fluid communication with the cell stack. A check valve (not shown) may be disposed within the wet hydrogen stream to prevent the backflow of water from separator 44. A liquid outlet 88 disposed either at flange 67 or proximate the flange end of separator 44 enables periodic drainage to allow the water collected in the vessel to be maintained at a selected level. Liquid outlet 88 is preferably disposed at the lowest point of separator 44 in order to effect the optimum drainage of separator 44.

End cap 65 can include an overflow port 86, a vapor outlet 90, and a pressure release port 92. Overflow port 86 provides drainage of separator 44 in the event that shell 68 fills completely with water. Overflow port 86 is preferably dimensioned to accommodate a flow rate that is greater than the maximum flow rate of the wet hydrogen stream into shell 68 through fluid inlet 72. By allowing shell 68 to be drained at a rate that exceeds the water input, the pressure of separator 44 is maintained at or below a desired limit. Vapor outlet 90 provides fluid communication between separator 44 and the drying apparatus and is preferably disposed at a distance from fluid inlet 72 to maximize the residence time of a wet hydrogen molecule within separator 44. Pressure release port 92 provides fluid communication between separator 44 and release 50 for the rapid purge of hydrogen if the pressure exceeds a selected amount. The dimensions of separator 44, particularly the diameter of shell 68, affect the velocity of the wet hydrogen stream entering through fluid inlet 72. In particular, the sudden expansion of the wet hydrogen stream as it enters separator 44 results in an abrupt increase in the flow area, thereby causing a decrease in the velocity of the hydrogen stream. The variation in velocity in turn affects the dispersion rate of hydrogen from the wet hydrogen stream.

In one embodiment, a level sensor stem 70, which houses a level sensing apparatus, is disposed within shell 68 of separator 44, intermediate end cap 65 and flange 67, and extends between end cap 65 and flange 67. In alternate embodiments, level sensor stem 70 can be replaced with various other level sensing devices, such as ultrasonic or optical transmitters and receivers, as well as combinations comprising at least one of the foregoing devices.

Also disposed within shell 68, intermediate end cap 65 and flange 67, are baffles 80. Baffles 80 are disposed along the lower length of level sensor stem 70 to effectively facilitate the diffusion of hydrogen from the water. Baffles 80 can be retained on level sensor stem 70 by collars 82 or can be supported by or connected to shell 68. The characteristic porosities of each baffle 80 may vary in relation to adjacently-positioned baffles, thereby imparting a porosity gradient over the length of shell 68. In one exemplary configuration of separator 44, baffles 80 proximate flange 67 are more porous than baffles 80 proximate end plate 84. In other words, baffle 80 proximate flange 67 can have a larger mesh size than the subsequent baffle 80 proximate plate 84. Additionally, any desired number of baffles 80 having the same or different mesh sizes can be employed. The desired number of baffles is typically a balance between a sufficient number to effectively separate the hydrogen from the water while minimizing the pressure drop across separator 44. Possible types of baffles include screen(s), perforated plate(s), and the like, as well as combinations comprising at least one of the foregoing types.

Baffle 80 has a cross-sectional geometry that substantially conforms to the separator shell 68 and comprises any material that is inert in the operating environment of separator 44, and which has the desired structural integrity. Possible materials include plastics, ceramics, metals, as well as alloys, cermets, composites, and mixtures comprising at least one of the foregoing. Some possible metals includes ferrous materials such as stainless steel, titanium, zirconium, and the like, as well as mixtures and alloys comprising at least one of the foregoing metals. Depending upon this size of the separator 44, and the desired degree of separation, one to several baffles 80 can be employed. For an electrochemical cell system, typically 1 to about 15 baffles are employed, with 1 to 5 baffles preferred.

As stated above, the porosity (e.g., the void area in the baffle) of baffles 80 can be substantially uniform or varied (in the pore/mesh size and the amount of open volume) and the porosity of adjacent plates can be the same or different. The porosity can be about 25% to about 75%. Plates disposed proximate end plate 84 preferably have a porosity (i.e., an opening volume) of about 25% to about 50%, while plates proximate flange 67 preferably have a porosity of about 50% to about 75%.

Shell 68 is preferably configured to include baffles 80 arranged such that upon diffusion of hydrogen gas to the vapor phase, the molecules of hydrogen gas encounter successively less porous baffles 80. As the hydrogen gas molecules diffuse through baffles 80 of successively less porosities, the hydrogen gas molecules become increasingly drier. The removed water coalesces and is returned to the liquid phase proximate the end of the shell at which the fluid inlet is disposed.

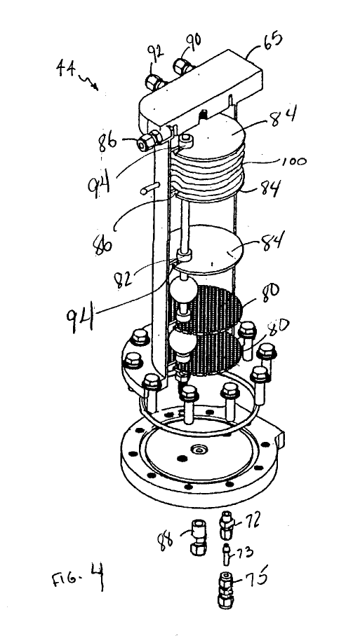

In order to more effectively remove water molecules from the hydrogen gas, a vapor cooling apparatus 100 can be disposed in separator 44, preferably adjacent the vapor phase, as is shown in FIG. 4. Vapor cooling apparatus 100 can comprise any thermal exchange unit/technique compatible with the operating conditions of separator 44. One exemplary embodiment of vapor cooling apparatus 100 comprises a coil disposed within shell 68 at an upper end of separator 44 (although anywhere in the shell is possible). The coil receives a coolant flow stream that removes heat from the vapor phase, causing the water to condense. Upon lowering the temperature of the vapor phase, water molecules attached to hydrogen molecules in the vapor phase are condensed out and returned to the liquid phase. Although the coil is shown as being disposed within shell 68, it should be understood by those of skill in the art that other configurations may be employed. For example, the coil may alternatively or additionally be disposed on an outer surface of shell 68. A cooling apparatus may further be disposed between the baffles and/or between a baffle and the plate. Typical coolants for the flow stream include, but are not limited to, liquids (e.g., water, ammonia, brines, alcohols, fluorocarbons, and halogenated hydrocarbons) and gases (e.g., air, nitrogen, hydrogen, and chloro-fluorinated methanes.) In alternate embodiments, the cooling apparatus can be a thermoelectrically cooled plate or tube.

The porosity of the baffles enables separation of the hydrogen gas and water by reducing the surface tension and allowing release of the hydrogen from the liquid water. The hydrogen gas molecules that migrate through the baffles contain less water, and thereby allow a substantially drier gas to be delivered from the separator. By delivering a substantially drier gas, downstream-located drying apparatuses can be operated more economically and efficiently; thereby resulting in a cost savings that may be significant over the life of the electrochemical cell into which the apparatuses are incorporated.

During operation of the electrochemical cell system into which separator 44 is incorporated, the wet hydrogen stream from the cell stack enters separator 44 through fluid inlet 72. (See FIG. 3). As the water level engages the first side of baffle 80, the stream is forced through the holes in the baffle, which enables hydrogen release from the wet hydrogen stream. The stream, which is now at least partially separated into a gas (e.g., hydrogen gas) and liquid (e.g., liquid water) phases, contacts a plate 84 that inhibits flow of the liquid water to the upper portion of the separator (e.g., past plate 84). For example, since the stream enters the separator under pressure, it is sprayed through the baffles and against the inlet side of the plate. Hydrogen gas that has been released from the stream passes through slot 94 toward vapor outlet 90. Optionally, the gas is cooled to remove water vapor from the gas.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the specification and drawings.

1. A gas/liquid separator, comprising:
a vessel having a fluid inlet, a liquid outlet, a vapor outlet and a vessel cross-sectional geometry;
an initial baffle and a subsequent baffle disposed within the vessel, between the fluid inlet and the vapor outlet, and having a baffle geometry substantially similar to the vessel cross-sectional geometry; wherein the initial and subsequent baffles comprise a plurality of openings providing fluid communication from a fluid inlet side to a baffle vapor outlet side of the initial baffle and the subsequent baffle; and
a solid plate disposed between the initial baffle and the vapor outlet, wherein the vapor outlet is in gaseous communication with a side of the solid plate opposite the vapor outlet.

2. The gas/liquid separator of claim 1, wherein the initial baffle openings have a size larger than the subsequent baffle openings.

3. The gas/liquid separator of claim 2, wherein at least one of the initial baffle and the subsequent baffle further comprises a screen.

4. The gas/liquid separator of claim 2, wherein at least one of the initial baffle and the subsequent baffle further comprises a perforated plate.

5. The gas/liquid separator of claim 4, wherein the initial baffle has an initial porosity of about 25% to about 50% and the subsequent baffle has a subsequent porosity of about 50% to about 75%.

6. The gas/liquid separator of claim 1, wherein the initial solid plate is disposed between the subsequent baffle and the vapor outlet.

7. The gas/liquid separator of claim 1, further comprising a cooling apparatus at least disposed in thermal communication with a portion of the separator between the solid plate and the vapor outlet.

8. The gas/liquid separator of claim 1, wherein the cooling apparatus is disposed within the shell.

9. A gas generating system, comprising:
an electrochemical cell; and
a gas/liquid phase separator in fluid communication with said electrochemical cell, wherein the gas/liquid separator comprises a vessel having a fluid inlet, a liquid outlet, a vapor outlet and a vessel cross-sectional geometry;
an initial baffle and a subsequent baffle disposed within the vessel, between the fluid inlet and the vapor outlet, and having a baffle geometry substantially similar to the vessel cross-sectional geometry; wherein the initial and subsequent baffles comprise a plurality of openings providing fluid communication from a fluid inlet side to a baffle vapor outlet side of the initial baffle and the subsequent baffle; and
a solid plate disposed between the initial baffle and the vapor outlet, wherein the vapor outlet is in gaseous communication with a side of the solid plate opposite the vapor outlet.

10. The gas generating system of claim 9, further comprising a gas storage vessel in fluid communication with the vapor outlet.

11. The gas generating system of claim 10, further comprising a drier fluidly disposed between the gas/liquid separator and the gas storage vessel.

12. The gas generating system of claim 11, further comprising a liquid storage vessel in fluid communication with the liquid outlet and with the electrochemical cell.

13. The gas generating system of claim 12, wherein the electrochemical cell is an electrolysis cell, and wherein the system further comprises a fuel cell in fluid communication with the gas storage vessel.

14. A method of separating a gas phase from a liquid phase, the method comprising:
introducing a stream to a gas/liquid separator;
passing an initial portion of the stream through an initial baffle;
passing a subsequent portion of the stream through a subsequent baffle,
wherein vapor and liquid are separated from the stream; and
removing the vapor from the separator;
wherein the initial baffle and the subsequent baffle are disposed within a vessel, between a fluid inlet and a vapor outlet, and have a baffle geometry substantially similar to a vessel cross-sectional geometry; wherein the initial and subsequent baffles comprise a plurality of openings providing fluid communication from a fluid inlet side to a baffle vapor outlet side of the initial baffle and the subsequent baffle.

15. The method of claim 14, further comprising cooling the vapor prior to removing the vapor from the separator.
